(19) United States
(12) Patent Application Publication
(10) Pub. No.: US 2008/0189998 A1
(43) Pub. Date: Aug. 14, 2008

(54) Hazard signs for use by truck drivers in cab of truck

(76) Inventor: Michael B. Thistlethwaite, Waynesburg, PA (US)

Correspondence Address: JAMES RAY & ASSOCIATES, 2640 PITCAIRN ROAD, MONROEVILLE, PA, 15146, US

(21) Appl. No.: 11/704,413

(22) Filed: Feb. 9, 2007

(51) Int. Cl. G09F 21/04

(52) U.S. Cl. 40/588

(57) ABSTRACT

Apparatus for alerting and/or reminding a truck driver of type of material being transported includes a base member having a plurality of first portions of a warning sign disposed thereon. Printed material is disposed on both sides of all but one side of one of such plurality of first portions of such sign. Another plurality of second portions of the sign is disposed on such base member. An edge of the plurality of such portions of the sign is aligned with an edge of such plurality of second portions of the sign. Printed material is disposed on both sides of all but one side of one of the plurality of such second portion of the sign. A mechanism engages engageable the base member, the plurality of first and second portions of the sign to enable flipping respective ones of the first and second plurality of such signs to display printed material.

### FIELD OF THE INVENTION

The present invention relates, in general, to truck drivers hauling hazardous materials and, more particularly, this invention relates to an apparatus to be installed in the cab of a truck to remind the driver of the type of load being carried and the loads travel restrictions.

### BACKGROUND OF THE INVENTION

Prior to the conception and development of the present invention, as is generally well known in the prior art, when certain materials are being transported a sign is carried on the outside of the truck to alert people of the dangers associated with the load being carried. However, the driver of the truck may forget the type of hazardous materials he is presently carrying because they carry so many different materials during the course of a week.

At the present time applicant is not aware of any device which can be positioned in the cab to remind them of the type of hazardous material they may be carrying and the restrictions on travel that is associated with such material. Such travel restrictions may be imposed in metropolitan areas or in tunnels over a highway, for example. These restrictions may also include certain times when such material can be transported.

### SUMMARY OF THE INVENTION

The present invention provides an apparatus for at least one of alerting and reminding a driver of a tractor trailer of a particular type of material being transported. This is of extreme importance if such material is a hazardous material. The apparatus comprises a base member having each of a predetermined size and a predetermined shape. There is, also, a first plurality of a first portion of a warning sign disposed on such base member. Each of the first plurality of such first portion of the warning sign likewise having each of a second predetermined size and a second predetermined shape. There is printed material disposed on both sides of all but one side of one of such first plurality of such first portion of the warning sign. Additionally, there is a second plurality of a second portion of such warning sign disposed on such base member. Each of the second plurality of such second portion of the warning sign having each of such second predetermined size and such second predetermined shape. A predetermined edge of such first plurality of such first portion of the warning sign is aligned with a predetermined edge of such second plurality of a second portion of the warning sign. Likewise, printed material is disposed on both sides of all but one side of one of the second plurality of such second portion of the warning sign. A means is engageable with each of the base member, the first plurality of such first portion of the warning sign adjacent such predetermined edge thereof and the second plurality of such second portion of the warning sign adjacent the predetermined edge for enabling flipping each of such first and second portions of respective ones of such first and second plurality of warning signs to thereby display the printed material disposed thereon to indicate such type of material being transported.

### OBJECTS OF THE INVENTION

It is, therefore, one of the primary objects of the present invention to provide a hazard sign for use in the cab of a truck which will remind driver of the cargo being carried therein.

Another object of the present invention is to provide a hazard sign for use in the cab of a truck which is easy to change.

Still another object of the present invention is to provide a hazard sign for use in the cab of a truck which is relatively light weight.

Yet another object of the present invention is to provide a hazard sign for use in the cab of a truck which is relatively inexpensive to manufacture.

An additional object of the present invention is to provide a hazard sign for use in the cab of a truck which is portable.

A still further object of the present invention is to provide a hazard sign for use in the cab of a truck which is easily attached to the inside of such cab.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a front view of one presently preferred embodiment of the warning sign manufactured in accordance with the invention;

FIG. 2 is a front view of an alternative embodiment of the warning sign according to the present invention;

FIG. 3 is a front view of another alternative embodiment of the warning sign according to the present invention;

FIG. 4 is a front view of still another alternative embodiment of the warning sign according to the present invention; and

FIG. 5 is a side view of the warning sign illustrated in FIG. 1 showing an alternative magnet means for attaching such warning sign inside the cab of a truck.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

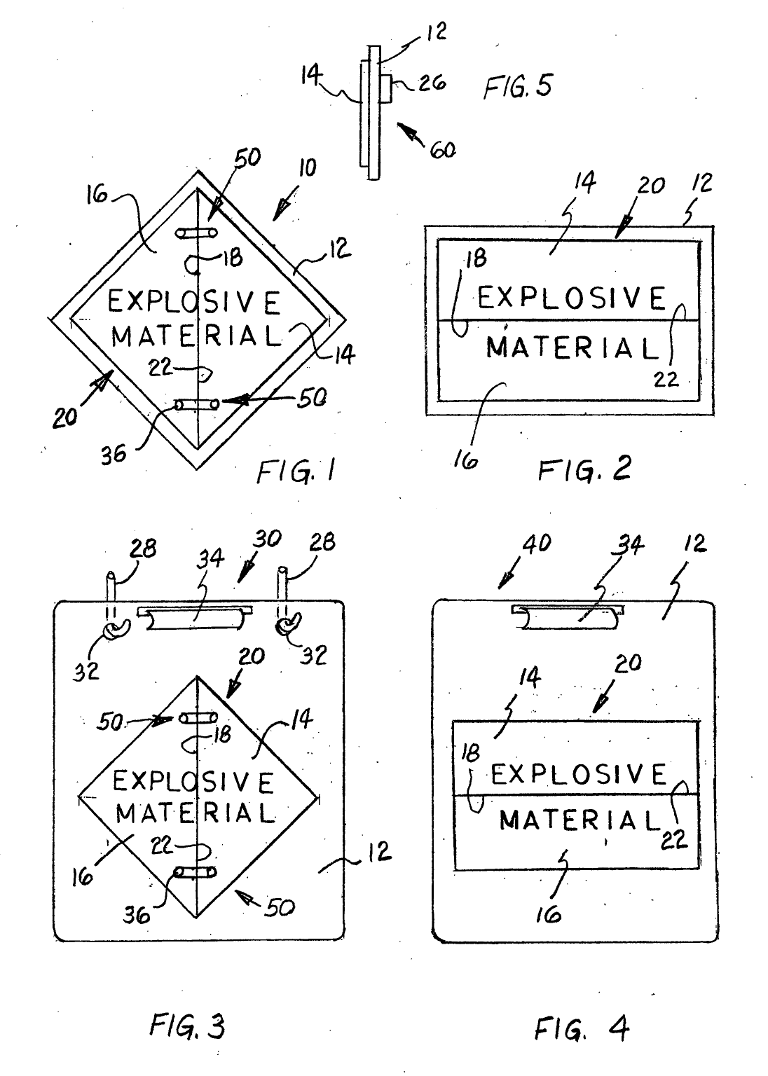

Reference is now made, more particularly, to FIG. 1. Illustrated therein is a presently preferred embodiment of an apparatus, generally designated 10, for at least one of alerting and reminding a driver of a tractor trailer (not shown) of a particular type of material being transported.

The apparatus 10 includes a base member 12 having each of a predetermined size and a first predetermined shape. Such first predetermined shape of such base member 12 is generally rectangular in the presently preferred embodiment of the invention.

There is a first plurality of a first portion 14 of a warning sign, generally designated 20, disposed on such base member 12. Each of the first plurality of such first portion 14 of the warning sign 20 includes each of a second predetermined size and a second predetermined shape. Printed material is disposed on both sides of all but one side of one of such first plurality of the first portion 14 of such warning sign 20.

A second plurality of a second portion 16 of such warning sign 20 is disposed on such base member 12. Each of the second plurality of such second portion 16 of the warning sign 20 having each of such second predetermined size and such second predetermined shape as such first plurality of such first portion 14 of the warning sign 20. There is a predetermined edge 18 of the first plurality of such first portion 14 of the warning sign 20 aligned with a predetermined edge 22 of such second plurality of a second portion 16 of the warning sign 20. Printed material is also disposed on both sides of all but one side of one of such second plurality of the second portion 16 of warning sign 20.

There is a means, generally designated 50, engageable with each of such base member 12, the first plurality of such first portion 14 of the warning sign 10 adjacent such predetermined edge 18 thereof and the second plurality of second portions 16 of such warning sign 10 adjacent the predetermined edge 22 for enabling flipping each of such first and second portions 14 and 16 of respective ones of the first and said second plurality of such warning sign 10 to thereby display such printed material disposed thereon to indicate such type of material being transported. Such means 50 is preferably a loop 36.

Reference is now made to FIG. 5 wherein there is illustrated a means, generally designated 60, for holding such apparatus 10 in a predetermined place inside such cab. Preferably, such means 60 is one of a magnet 26 or a hook 28 (FIG. 3) disposed in apertures 32 formed through base member 12.

Reference is now made to FIGS. 3 and 4 wherein the apparatus, generally designated 30 and 40, further includes a clip means 34 attached to such base member 12 for holding papers (not shown).

According to the present invention, the second predetermined shape of such first plurality of first portions 14 of such warning sign 10 and such third predetermined shape of the second plurality of second portions 16 of warning sign 10 are substantially identical.

In the broad sense such second predetermined shape of such first plurality of first portions 14 of warning sign 10 and the third predetermined shape of such second plurality of second portions 16 of the warning sign 10 are one of generally rectangular and generally triangular. Preferably. they generally rectangular.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for at least one of alerting and reminding a driver of a tractor trailer of a particular type of material being transported, said apparatus comprising:
(a) a base member having each of a predetermined size and a first predetermined shape;
(b) a first plurality of a first portion of a warning sign disposed on said base member, each of said first plurality of said first portion of said warning sign having each of a second predetermined size and a second predetermined shape, printed material is disposed on both sides of all but one side of one of said first plurality of said first portion of said warning sign;
(c) a second plurality of a second portion of said warning sign disposed on said base member, each of said second plurality of said second portion of said warning sign having each of said second predetermined size and said second predetermined shape, a predetermined edge of said first plurality of said first portion of a warning sign aligned with a predetermined edge of said second plurality of a second portion of said warning sign, printed material is disposed on both sides of all but one side of one of said second plurality of said second portion of said warning sign;
(d) a means engageable with each of said base member, said first plurality of said first portion of said warning sign adjacent said predetermined edge thereof and said second plurality of said second portion of said warning sign adjacent said predetermined edge for enabling flipping each of said first and said second portions of respective ones of said first and said second plurality of said warning signs to thereby display said printed material disposed thereon to indicate such type of material being transported.

2. An apparatus, according to claim 1, wherein said apparatus further includes a means for holding said apparatus in a predetermined place inside such cab.

3. An apparatus, according to claim 1, wherein said apparatus further includes a clip means attached to said base member for holding papers.

4. An apparatus, according to claim 1, wherein said predetermined shape of said base member is generally rectangular.

5. An apparatus, according to claim 1, wherein second predetermined shape of said first plurality of said first portion of said warning sign and said third predetermined shape of said second plurality of a second portion of said warning sign are substantially identical.

6. An apparatus, according to claim 5, wherein said second predetermined shape of said first plurality of said first portion of said warning sign and said third predetermined shape of said second plurality of a second portion of said warning sign are one of generally rectangular and generally triangular.

7. An apparatus, according to claim 5, wherein said second predetermined shape of said first plurality of said first portion of said warning sign and said third predetermined shape of said second plurality of a second portion of said warning sign are generally rectangular.

8. An apparatus, according to claim 1, wherein said means engageable with each of said base member, said first plurality of said first portion of said warning sign adjacent said predetermined edge thereof and said second plurality of said second portion of said warning sign adjacent said predetermined edge for enabling flipping each of said first and said second portions of respective ones of said first and said second plurality of said warning signs to thereby display said printed material disposed thereon is a loop connected to said base member.

9. An apparatus, according to claim 2, wherein said means for holding said apparatus in a predetermined place inside such cab is one of a magnet and a hook.
